(19) United States
(12) Patent Application Publication
(10) Pub. No.: US 2004/0215782 A1
(43) Pub. Date: Oct. 28, 2004

(54) System and method of managing message exchanges between users of a matching service

(75) Inventor: Omar A. Syed, Lakewood, OH (US)

Correspondence Address: Erik J. Overberger, Esq., Fay, Sharpe, Fagan, Minnich & McKee, LLP, 7th Floor, 1100 Superior Avenue, Cleveland, OH, 44114-2518, US

(73) Assignee: 4YOU NET SERVICES, INC.

(21) Appl. No.: 10/420,130

(22) Filed: Apr. 22, 2003

(51) Int. Cl. G06F 15/16; G06F 17/00; G06F 7/00

(52) U.S. Cl. 709/227; 707/104.1

(57) ABSTRACT

A method of managing message exchanges between users of a matching service is provided. In the method, a matching service database of a plurality of users that includes registration information for each of said plurality of users is maintained. The registration information includes a membership level. Access to the matching service database is provided over a network to the plurality of users. A message is received from a first user of the plurality of users intended for a second user of the plurality of users. A second user membership level is determined for the second user and the message is encoded if the second user level is a first level. The message is provided to the second user.

### BACKGROUND OF THE INVENTION

1. Field of the Invention

The present invention relates to a system and method of managing message exchanges between users of a matching service. More specifically, the present invention relates to a system and method of registering users in one of at least two levels, obtaining and storing user profile information on said users, identifying other registered users based on desired profile information and managing messages between users including preventing, obstructing and/or coding at least portions of messages sent to users registered in a specified one of said at least two levels. The present invention finds particular application as an internet-based system and method wherein users access a central system server and database and send messages to one another through said system service and database via the internet. It will be appreciated, however, that the invention may relate to other similar environments and applications.

2. Description of the Prior Art

Matching services are generally well known and are found in a variety of formats utilizing a variety of technologies. In one format, a central repository of user profiles is stored and made available for searching. Each user profile represents an individual and includes specific information said to characterize the individual represented. For example, the user profile may include several items such as a person's height, body type, geographical location and interests. The central repository may be available for searches by individuals who pay a specified fee to the owner or operator of the central repository. Searching individuals may be able to specify desired items or characteristics that they seek in an individual and the repository owner may be able to perform a search of all user profiles contained in the central repository and provide a filtered list of individuals having user profiles that include the desired items or characteristics. Alternatives of this type of format can include those where no fee is required and/or where access to all user profiles is provided to the searching individual without the ability to filter the user profiles by specifying search criteria.

The variety of technologies used to facilitate matching services ranges, from static informative services provided via basic print media, including personal advertisements placed in newspapers, magazines and other publications, to interactive databases that may be communicated with by telephone or through the internet. Online or internet based matching services provide many advantages and have recently risen in popularity as the number of people with internet access has grown. The advantages of these services include private access from a personal computer, easily searchable databases, and, optionally, the ability to communicate with desired users found in the database through the sending, transmitting, and receiving of electronic text messages. This form of communication is advantageous because it is generally less invasive relative to live communication, i.e., in person or over the telephone, can be conducted anonymously, and does not require both parties to be available at the same time.

One disadvantage of many online, fee-based matching services is the difficulty in acquiring new individuals and getting new individuals to subscribe. Oftentimes, individuals are reluctant to pay a fee for such a service without knowing the likelihood that the individual will be sought after or contacted by other members searching the profiles offered by the matching service. If a potential subscriber could verify or confirm that his or her profile would indeed be sought after, then the potential subscriber is much more likely to subscribe for some prescribed fee. Thus, it is desirable for the matching service provider to provide a means for confirming interest in ones profile, particularly to potential subscribers. At the same time, the matching service provider cannot provide potential users with unfettered access to the matching service or potential subscribers would have no incentive to subscribe, i.e., they could get what they needed from the matching service without paying a fee.

In other online applications, it is common to provide a potential user or subscriber with free access for a limited period of time commonly referred to as a trial period. In these applications, the potential subscriber has unfettered access for a limited time, which allows the potential subscriber to determine if a subscription for a fee would be desirable. Although such trial periods could be used in matching services, they suffer a severe drawback: matching service users are often looking for a single match and upon finding said single match the user may no longer use the matching service. In other words, many potential subscribers to a matching service will only use the matching service for a limited time. Using a free trial period, many potential subscribers may extract enough information from the matching service such that subscription for a fee is no longer desirable.

Thus, there is a need for an online matching service that provides potential subscribers confirmation that the matching service is worthwhile, i.e., others using the service will want to contact the potential subscriber, while maintaining a desire and need for the matching service in the potential subscriber. In such a system, the potential subscriber is more likely to pay a subscription fee to use the matching service because the potential subscriber has confirmed or is able to confirm the value of the matching service.

### SUMMARY OF THE INVENTION

The present invention provides a new and improved matching service system and method that overcomes the foregoing difficulties and others and provides the aforementioned and other advantageous features. More specifically, in accordance with one aspect of the present invention, a method of managing message exchanges between users of a matching service is provided. In accordance with this aspect of the invention, a matching service database of a plurality of users that includes registration information for each of said plurality of users is maintained. The registration information includes a membership level. Access to the matching service database is provided over a network to the plurality of users. A message is received from a first user of the plurality of users intended for a second user of the plurality of users. A second user membership level is determined for the second user and the message is encoded if the second user level is a first level. The message is provided to the second user.

In accordance with another aspect of the present invention, a method of processing messages sent between users of a matching service is provided. More particularly, in accordance with this aspect of thee invention, an original message is received from one of a plurality of users intended for another specified user of the plurality of users. The original message is preserved. The specified user is compared to a database of users to determine a membership level of the specified user. The specified user is provided with the original message when the membership level of the specified user is standard. The original message is encoded to create an encoded message when the membership level of the specified user is less than standard. The encoded message is provided to the specified user when the membership level of the specified user is less than standard.

### BRIEF DESCRIPTION OF THE DRAWINGS

The invention may take physical form in various components and arrangements of components and in various steps and arrangements of steps. The drawings are only for purposes of illustrating a preferred embodiment and are not to be construed as limiting the invention.

FIG. 1 is a schematic overview of a system for matching users of an online matching service and exchanging messages between users of the online matching service according to a preferred embodiment of the present invention.

FIG. 2 is a block diagram illustrating an exemplary set of processing steps for using the system of FIG. 1.

FIG. 3 is a block diagram illustrating an exemplary set of processing steps for managing the system of FIG. 1.

FIG. 4 is a block diagram illustrating an exemplary set of processing steps for managing the exchange of messages on the system of FIG. 1.

### DETAILED DESCRIPTION OF THE PREFERRED EMBODIMENTS

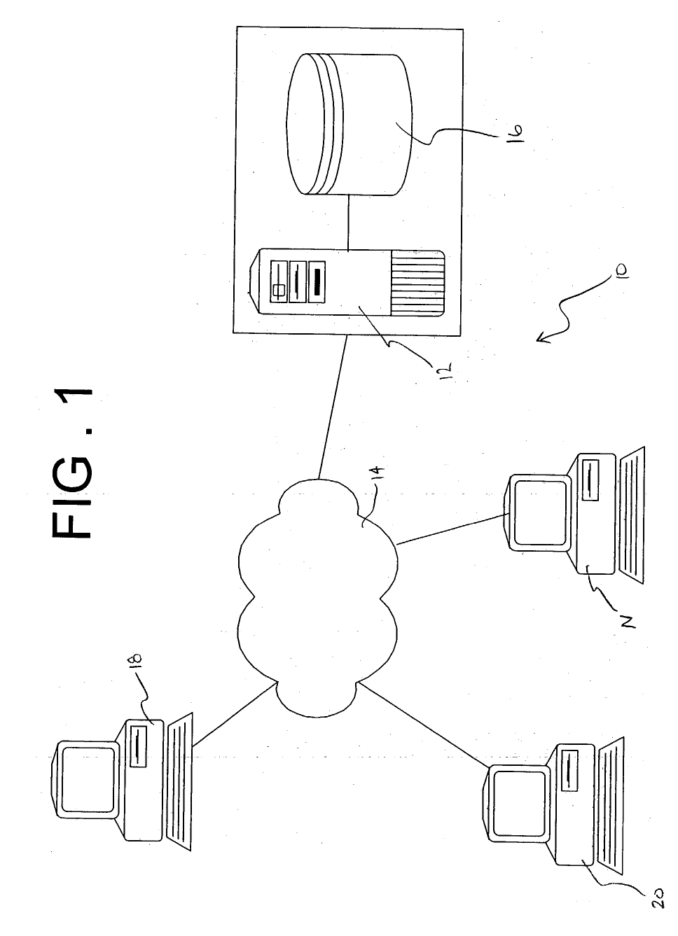

Referring now to the drawings wherein the showings are for purposes of illustrating the preferred embodiments of the invention only and not for purposes of limiting the same, FIG. 1 shows a system for matching users of an online matching service and exchanging messages between said users generally designated by reference numeral 10. The system includes a web or matching service host server 12 connected to a network 14 such as the internet. The hosting server 12 includes or is further connected to a matching service database 16. The database 16 is configured to store information on a plurality of users of the system 10 as will be described in more detail below. Alternatively, the database 16 could be a plurality of databases linked to one another.

The system 10 further includes at least a first communicating device 18 and a second communicating device 20 both capable of connecting and communicating with the host server 12 over the network 14. A first user can communicate with the system 10 by using the first communicating device 18 and a second user can communicate with the system 10 by using the second communicating device 20. In this manner, both the first and second users can access the database 16 through the server 12 for purposes of recording information about themselves and/or retrieving information about one another or other users already stored or recorded in the database 16. Further, the first and second users can communicate with each other through the network 14 and the host server 12 as will be described in more detail below. The first and second communicating devices 18, 20 can be separated or geographically remote relative to one another which allows the first and second users access to the system 10 even if they are located remotely relative to one another.

Any additional number of users can communicate with the system 10 through the use of additional communicating devices. In FIG. 1, another communicating device is shown with the reference letter N attached thereto which is representative of any number of additional communicating devices operated by users to connect and communicate with the host server 12 and the database 16 via the network 14. Of course, it is also possible to have multiple users connecting and communicating with the host server 12 and accessing the database 16 through one or more shared communicating devices. In any form, the system 10 is adopted to be used by two or more users employing any number of communicating devices to communicate with the host server 12, the database 16 and each other via the network 14.

When a user, such as the first user, desires to access the server 12 and database 16, the user connects to the network 14 with a communicating device, such as the first communicating device 18. In the preferred embodiment, the network 14 is the internet and the communicating devices 18,20 are personal computers with internet access. Alternatively, the network 14 could be any type of network such as a proprietary network, a local intranet, a wireless network, a telephone network, etc., and the communicating devices could each be any device adapted to communicate with one of the aforementioned networks such as a local server, a telephone, a wireless phone, a personal digital assistant (PDA), a pager, a palm-top computer, a personal computer, etc.

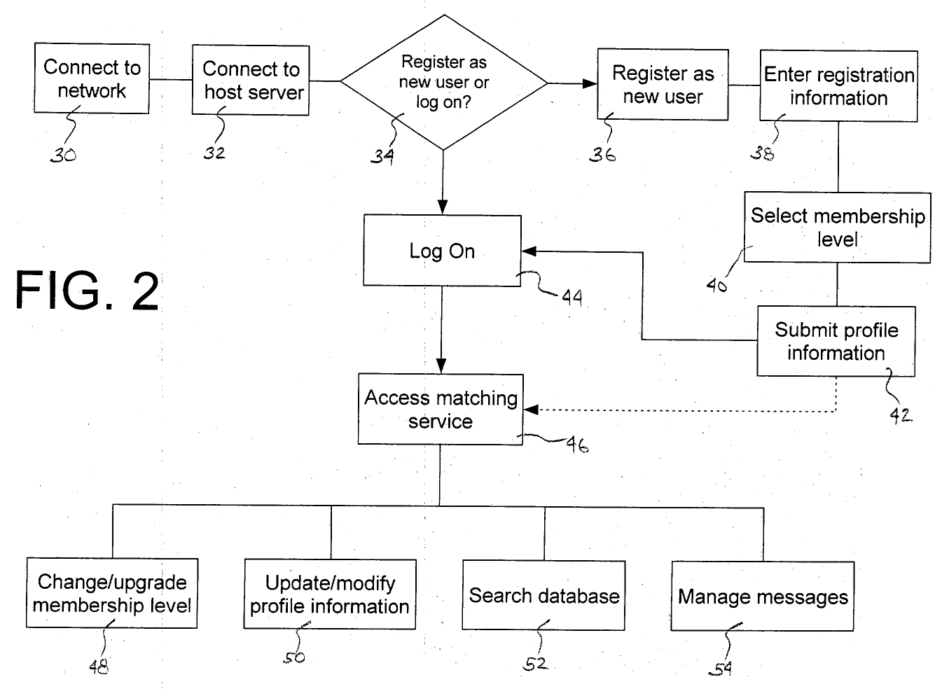

More specifically, with additional reference to FIG. 2, the first user uses the first communicating device 18 to connect to the internet 14 in a conventional manner (step 30). The first user can then connect to the host server 12 (step 32) through conventional means such as by using a web browser on the first communicating device 18 to view a matching service web page residing on the host server 12 and generally made available to anyone connected to the internet 14. At the matching service website, the first user has the option of registering as a new user or logging on as an existing user (step 34). For example, the website may direct first-time users to a link labeled “register as a new user” and returning or existing user to a link labeled “registered users.”

If the first user chooses to register as a new user, the first user communicates that choice in a conventional manner such as by using a mouse or keyboard connected to the first communicating device 18 and selecting an appropriate icon or link on a display screen connected to or formed as part of the first communicating device 18 (step 36). The first user may then be directed to a new web page wherein the first user is prompted to register as a new user. This may include, for example, providing the first user with one or more blank fields to be filled-in as instructed. For example, the first user may be instructed to provide one or more of the following in one or more corresponding fields: name, address, telephone, user name, access password, email address, etc. One or more of these fields may be required fields that must be filled-in before the user is able to register. The first user can then enter this registration information which can be stored in the database 16 (step 38). After filling-in the appropriate fields, the first user can then be directed to select or click a “submit” link for completing the registration process.

Registration may further include requiring the first user to select a membership level. More specifically, the server 12 may prompt the first user to choose a user or membership level. In the first preferred embodiment, the first user has the choice of registering as (1) a first level user or guest member or (2) a second level user or standard member. The level of membership is used to determine how messages are received by the user as will be described in more detail below. The first user level is available to the first user without a fee associated therewith. The second user level is available to the first user for a predetermined or fixed fee. Registration as a second level user requires the first user to submit payment using any conventional online pay system. In either case, the user selects the membership level of his/her choice and submits payment if required (step 40). Once the first user chooses a level, this choice is recorded and saved in the database 16.

Once registered, the first user has the opportunity to submit a profile or provide profile information said to be representative of the first user. The profile requested and/or provided by the first user may include, for example, information concerning the first user's physical appearance, interests, and/or physical location; one or more photographs of the first user; desired attributes in a companion; etc. Similar to the information provided during registration, submitting a profile may entail selecting a link and being directed to a profile submission web page wherein the first user is instructed to provide information as described above in blank fields. The first user enters profile information and, after providing the information, the first user can select or click on a submit link (step 42). The profile submitted by the first user, also referred hereinafter as the first user profile, can then be stored in the database 16 and made available to other registered users. After registering and providing profile information, the first user can log on (step 44) as described in more detail below or, optionally, be immediately directed and granted access to the matching service (step 46).

As should be readily apparent, many users are able to register with the matching service and maintain profiles in the database 16. For example, the second user also could register and submit a profile to the system 10 using the second communication device 20. As already mentioned, because of the nature of the internet 14, the second user could be geographically remote relative to the first user and both could be geographically remote relative to the host server 12 and the database 16. Likewise, any additional number of users, possibly in geographically remote areas, could register and submit profiles using any number of additional communication devices N.

When presented with the choice to register as a new user or log on (step 34), if the first user is already registered and chooses to log on, the first user communicates that choice in the same manner as if registering as a new user, i.e., selecting an appropriate icon or link on the display screen of the first communicating device 18, and may be directed to a new web page wherein the first user is prompted to log on. Logging on can include, for example, requesting the registered user to provide a user name and password associated with the first user and providing blank fields for the first user to enter his or her user name and password. The first user can then provide his or her user name and password to the host server 12 (step 44). The host server 12 compares or verifies the provided log on information against registration information stored in the database 16. Assuming the log in information is verified, the first user is then permitted access to the matching service (step 46). If the first user is a newly registered user, he/she may be optionally permitted to bypass the log on step after completing registration as mentioned above.

Once the first user has access to the matching service, either by logging on or newly registering and bypassing the log on step, the first user is presented with a menu of options. The available options can include, for example, changing the membership level associated with the first user, updating or modifying the profile associated with the first user, searching the database 16 for desired profiles said to be representative of other users, and managing messages to and from other users. These options are generally available to the first user any time the first user has access to the matching service.

Changing or upgrading the membership level associated with the first user (step 48) would allow the first user to upgrade his/her membership. For example, if the first user were only registered as a guest member, the first user could decide to upgrade to a standard member. This would require submission of a prescribed fee after which the first user's registration information would be modified to record that the first user is a standard member in the database 16.

Updating or modifying the profile associated with the first user (step 50) would allow the first user to keep the first user profile current, change the amount of information available about the first user, etc. Similar to submitting a new profile, the first user would have the opportunity to edit any existing profile information and any changes would be recorded in the database 16.

Searching the database 16 for desired profiles (step 52) would require the first user to define search parameters to be compared to the other user profiles stored in the database 16. For example, the first user may specify that he is seeking a twenty to thirty year old female in the New York City area. The host server 12 would search the database 16 for all profiles that match these specifics and a list of users or, more specifically, user names having matching profiles associated therewith would be communicated to the first user. The first user could then optionally review the entire profile associated with one or more of the user names identified in the search results.

The first user could also choose to manage messages to and from other users (step 54). This could include, for example, viewing messages sent to the first user; deleting messages sent to the first user; creating new messages, responding to sent messages and sending messages to other users; etc. Managing messages from the first user's perspective can be similar to conventional email message managing software. Notably, however, messages sent in the system 10 are directed or routed through the host server 12 for processing and not sent directly to the desired recipient as will be described in more detail below.

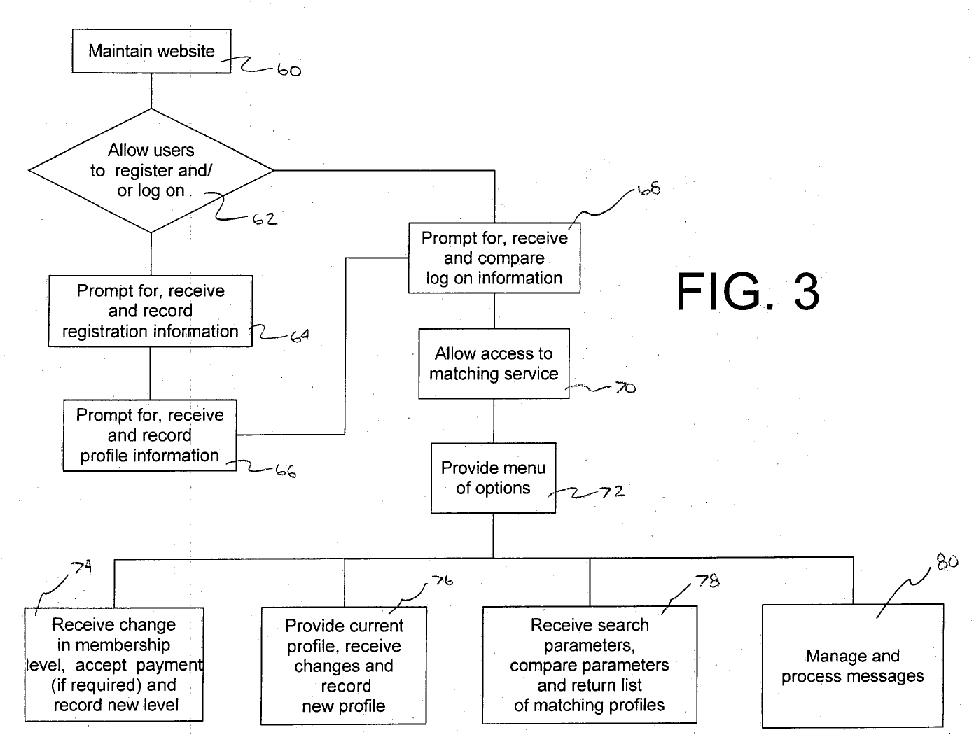

With additional reference to FIG. 3, the administration of the system 10 will now be described. The host server 12 allows users to connect thereto using the network 14. More specifically, the host server 12 hosts or maintains a matching service web site thereon (step 60) that is viewable through the communication devices 18,20,N over the network 14. Although the host server 12 is shown as a single server, it is to be appreciated that the host server 12 could alternatively be a plurality of servers or any other like device. Through the web site, the host server 12 allows users to register and/or log on (step 62).

When a user chooses to register, the host server 12 (1) prompts the user to provide and submit registration information concerning the user and (2) receives and records the provided registration information in the database 16 (step 64). The host server 12 can also prompt the user to provide and submit profile information about the user which is then received and recorded in the database 16 (step 66). When a user is registered and chooses to log on, the server 12 prompts the user to provide log on information (step 68). After log on information is provided by the user, and received by the server 12, the server 12 compares the provided log on information against the registration information stored in the database 16 (step 68). For example, the server 12 may prompt the user to provide a user name and password. After the user provides this information, the server 12 compares the provided information against all the user registration records contained in the database 16. As long as the provided information matches one of the records, the server 12 allows access to the matching services which may be done by directing the user to or sending the user a matching services web page (step 70). If the provided information does not match any of the registration records contained in the database 16, the server 12 will not provide access to the matching service.

Once access is granted to the matching service, the server 12 provides the user the menu of options (step 72) as described above. From the menu of options, when a user chooses to upgrade his/her membership level, the server 12 allows the user to change his/her membership level and submit payment, if required, through any conventional online pay method (step 74). Upon payment, the server 12 changes the membership level associated with the user in the database 16 (step 74). When a user chooses to edit his/her profile, the server 12 provides the currently recorded profile information associated with the user and allows the user to edit this information (step 74). The server 12 then accepts edits or changes to the profile and, upon completion of said edits, the server 12 re-records the profile information in the database 16 (step 76).

When a user chooses to search for other profiles, the server 12 allows the user to provide search parameters as already described. The server 12 receives the search parameters and compares them against the profile records stored in the database 16 (step 78). To compare, the server 12 compares the search parameters against all profile records in the database 16 and returns a list of user names (step 78). The returned list of user names will each include a profile record that includes information that matches or is contained within the search parameters. The server 12 may also allow the user to view all or part of each of the profile records associated with each of the user names returned from the search.

When a user chooses to manage messages, the server 12 will notify the user of any messages sent to the user, allow the user to compose and send messages, allow the user to delete messages and allow the user to view messages sent to the user (step 80). It is expected that the user will often search for other profiles as described above to find users that may be receptive to receiving a message from the user. When the user finds a desired profile, the user may send a message over the system 10 and through the server 12 to the user name associated, in the database 16, with the desired profile. In a like manner, the other users may send a message to the user.

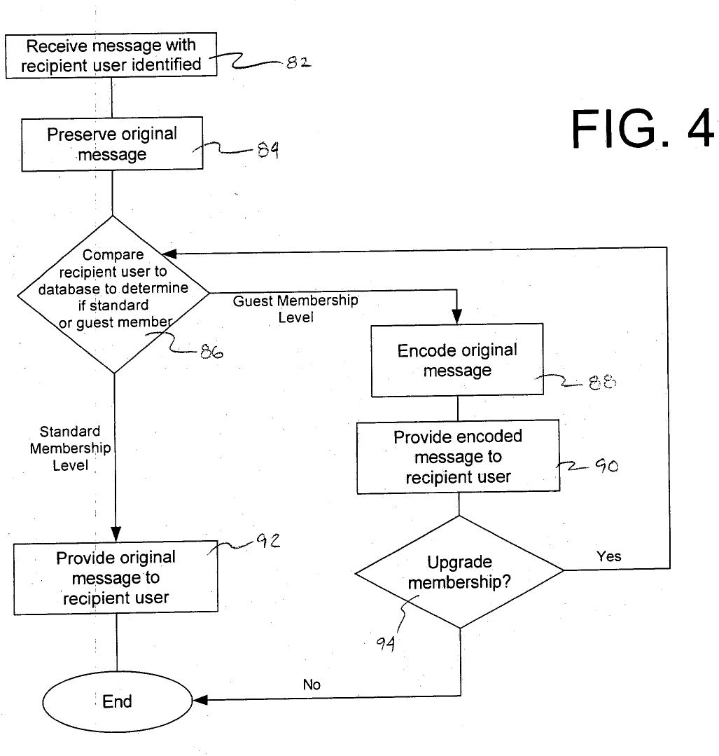

In step 78 of FIG. 3, the server 12 manages and processes messages sent to and from users of the system 10. More specifically, with reference to FIG. 4, the server 12 receives an original message from a user that includes a specified user name representative of a recipient user to which the message is to be sent (step 82). The message then is processed by the server 12 prior to allowing the specified user to view the sent message. More specifically, to process the message, the server 12 first preserves a copy of the original message (step 84). In the preferred embodiment, preserving the message is done by storing or recording the message in the database 16. Then, when the recipient user chooses to view the message, the server 12 compares the identified recipient user to the registration records stored in the database 16 to determine the membership level of the recipient user (step 86). If the user level of the recipient is the guest membership level, the message will be encoded or altered (step 88) and only the encoded message will be provided to the recipient user (step 90) as will be described in more detail below. If the user level of the recipient user is the standard membership level, then the original message that was preserved in step 84 is provided to the recipient user (step 92).

Thus, if the first user desired to send a message to the second user using the system 10 of the present invention, the first user would compose and send a message under the manage messages step 54 (FIG. 2) wherein the second user would be designated as the intended recipient. The server 12 would receive the message from the first user in step 82. Then, the server 12 would preserve the original message for later viewing by the intended recipient in step 84. Next, when the second user elects to view messages sent to the second user over the system 10, the server 12 would look up the intended recipient, the second user, in the database 16 and determine the membership level of the second user in step 86. If the second user were a standard member, the server 12 would provide the original message to the second user in step 92 for viewing by the second user. If the second user were a guest member, the server 12 would encode the original message in step 88 and provide the encoded message to the second user in step 90 for viewing by the second user.

In the preferred embodiment, the step 88 of encoding a sent message is done by replacing all alphanumeric characters in the message with a single type of character such as the letter “x”. Further, all underscores (“_”) and at symbols (“@”) in the message are replaced by the single type of character. Other characters including periods, commas, dashes and the like are unchanged and the general format of the message including character spaces, line, spaces, paragraph breaks and the like generally remains unaltered or preserved. Of course, other encoding variations are possible and all such variations are to be considered within the scope of the present invention.

Continuing with the example provided above, the preserved original message of step 84 originating from the first user would be available to the second user the next time the second user logs on to the system 10 and accesses the matching service. If the second user were a standard user, the second user would be able to view the original message. If the second user were a guest user, the original message would be encoded as described above and only the encoded message would be available to the second user for viewing. If viewing only the encoded message, the second user would know that he/she received a message but would not be able to understand the content of the message.

It is expected that if the second user were a guest user and could only view the encoded message, the second user might be enticed into paying the prescribed fee to upgrade his/her membership to the standard level so that the second user could view the message. Accordingly, the recipient user of an encoded message is provided with the option of upgrading his/her membership to the standard level (step 94). If the user chooses to upgrade his/her membership, the message is re-processed by the server 12 so that the recipient user can view the original message. The advantage of providing the encoded message is that a user who receives one or more encoded messages is more likely to upgrade his/her membership for a fee because such a user has already confirmed that other users are likely to contact him/her.

The invention has been described with reference to a preferred embodiment. Obviously, modifications and alterations will occur to others upon reading and understanding the preceding detailed description. It is intended that the invention be construed as including all such modifications and alterations insofar as they are within the scope of the appended claims or the equivalents thereof.

What is claimed is:

1. A method of managing message exchanges between users of a matching service, the method comprising:
a) maintaining a matching service database of a plurality of users that includes registration information for each of said plurality of users; said registration information including a membership level;
b) providing access to said matching service database over a network to said plurality of users;
c) receiving a message from a first user of said plurality of users intended for a second user of said plurality of users;
d) determining a second user membership level for said second user and encoding said message if said second user level is a first level; and
e) providing said message to said second user.

2. The method according to claim 1 wherein the step of determining said second user membership level includes:
receiving identifying information about said second user with said message;
using said identifying information to find second user registration information in said database; and
getting said second user membership level from said second user registration information.

3. The method according to claim 1 wherein the step of encoding said message includes:
replacing at least some characters in said message with a different character; and
maintaining spacing contained in said message.

4. The method according to claim 1 wherein said database further includes profile information for each of said plurality of users.

5. The method according to claim 4 wherein said profile information for each user is supplied by that user and purports to provide information about that user.

6. The method according to claim 4 further including the steps of:
prompting for entry of profile information for each user;
optionally receiving profile information for each user; and
optionally recording profile information for each user.

7. The method according to claim 4 further including the steps of:
receiving updated profile information from any of said plurality of users; and
rerecording said profile information in said database.

8. The method according to claim 4 further including the steps of:
receiving search parameter information from said first user;
comparing said search parameter information to said profile information for each user; and
identifying users having profile information matching said search parameter information to said first user.

9. The method according to claim 1 further including the steps of:
prompting for entry of registration information for each user;
receiving registration information for each user; and
recording registration information received for each user in said database.

10. The method according to claim 1 further including the steps of:
receiving log on information from said first user;
comparing said log on information to said registration information; and
only providing access to said database if said log on information matches said registration information.

11. The method according to claim 1 further including the steps of:
permitting said second user to change said second user membership level to a second level for payment of a fixed fee; and
removing any encoding from said message after said second user changes said second user membership level to said second level.

12. A method of processing messages sent between users of a matching service, the method comprising:
a) receiving an original message from one of a plurality of users intended for another specified user of said plurality of users;
b) preserving said original message;
c) comparing said specified user to a database of users to determine a membership level of said specified user;
d) providing said specified user with said original message when said membership level of said specified user is standard;
e) encoding said original message to create an encoded message when said membership level of said specified user is less than standard; and
f) providing said encoded message to said specified user when said membership level of said specified user is less than standard.

13. The method according to claim 12 wherein the step of encoding said original message to create an encoded message includes at least one of replacing at least some alphanumeric characters and at least some symbol characters in said original message with other characters.

14. The method according to claim 13 wherein all alphanumeric characters and at least some symbol characters are replaced by a single character.

15. The method according to claim 13 wherein spacing in said original message is preserved.

16. The method according to claim 12 further including the step of:
upgrading said membership level of said specified user to standard when said membership level of said specified user is less than standard and said specified user pays a prescribed fee.

17. The method according to claim 12 further including the step of:
providing said original message to said specified user when said membership level of said specified user is less than standard after said user upgrades said membership level to standard.
